(19) United States
(12) Patent Application Publication
(10) Pub. No.: US 2008/0289259 A1
(43) Pub. Date: Nov. 27, 2008

(54) Integrated Channel Regulator for Vehicle Door

(75) Inventors: Terrence P. Costigan, Fenton, MI (US); Charles H.G. Henderson, Canton, MI (US); John D. Caron, St. Clair Shores, MI (US); Michael D. Youngblood, Pontiac, MI (US); Henry J. Nykiel, Howell, MI (US); William C. Bisnack, Macomb, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/752,946

(22) Filed: May 24, 2007

(51) Int. Cl. B60J 1/00

(52) U.S. Cl. 49/502

(57) ABSTRACT

A vehicle door that may include a latch/window regulator module and rear and forward integrated channel/regulators, is disclosed. The rear integrated channel/regulator may include a glass run channel that is integral with a window regulator guide rail, and may also have a door latch assembly mounted to it. Other features may be integral with and extend from the rear integrated channel/regulator. The forward integrated channel/regulator may include a glass run channel that is integral with a window regulator guide rail, and may include an integral flange to which a cable drum and motor are mounted. The latch/window regulator module may be pre-assembled before being assembled into the vehicle door.

### BACKGROUND OF THE INVENTION

The present application relates generally to a vehicle door, and more particularly to vehicle doors having integrated glass run channels and window regulators.

For typical vehicle doors with a movable window glass, glass run channel assemblies are separate from window regulator guide rails. The guide rails, along with the rest of the window regulator assembly, are typically located between and spaced from the glass run channels. Thus, the different assemblies can be installed and aligned separately. But this requires having a significant number of components and multiple assemblies, which can incur greater cost and assembly time than is desirable.

More recently, some have proposed combining the glass run channels and the window regulator assemblies into one subassembly. However, the proposed solutions, while combining these components, have proven inadequate. Some have created conflicting inboard-outboard constraints on the window glass in that both the window regulator assembly and the run channels provide inboard/outboard positioning of the glass. These conflicting constraints can result in a higher level of drag on the window glass or concerns with glass rattle during door closing. Some solutions require attachment to a door inner panel at locations that do not allow for door trim to be expanded outboard, preventing additional interior room/storage pockets in the door from being created. Some solutions may require undesirable changes in the door structure. And, some proposals require major changes to the structure of a conventional door, which may be costly to implement and create other undesirable complications in door structure/mechanisms, thus minimizing the benefits from combining the window regulator assembly and glass run channels in the first place.

### SUMMARY OF THE INVENTION

An embodiment contemplates a rear integrated channel/regulator mountable to a door inner panel of a vehicle door for guiding a window glass. The rear integrated channel/regulator may comprise a rear glass run channel shaped to slidably receive the window glass; a rear window regulator guide rail, extending from and integral with the rear glass run channel, including a top rear pulley and a bottom rear pulley rotatably mounted to the rear window regulator guide rail and adapted to guide a cable therearound; and a door handle support flange extending from the rear glass run channel.

An embodiment contemplates a latch/window regulator module mountable in a vehicle door for guiding and moving a window glass. The latch/window regulator module may comprise a rear integrated channel/regulator including a rear glass run channel shaped to slidably receive the window glass, and a rear window regulator guide rail, extending from the rear glass run channel, including a top rear pulley and a bottom rear pulley rotatably mounted to the rear window regulator guide rail; a forward integrated channel/regulator including a forward glass run channel shaped to slidably receive the window glass, and a forward window regulator guide rail, extending from the forward glass run channel, including a top front pulley and a bottom front pulley rotatably mounted to the forward window regulator guide rail; a door latch assembly mounted to the rear integrated channel/regulator; and a window regulator cable assembly operatively engaging the top rear pulley, the bottom rear pulley, the top front pulley and the bottom front pulley.

An embodiment contemplates a forward integrated channel/regulator mountable to a door inner panel of a vehicle door for guiding a window glass. The forward integrated channel/regulator may comprise a forward glass run channel shaped to slidably receive the window glass; a forward window regulator guide rail, extending from and integral with the forward glass run channel, including a top front pulley and a bottom front pulley rotatably mounted to the forward window regulator guide rail and adapted to guide a cable therearound; a motor flange, extending from and integral with the forward glass run channel and forward window regulator guide rail; and a cable drum mounted to the motor flange and adapted to operatively engage the cable.

An advantage of an embodiment is that the integrated channel/regulators may decrease the overall mass of the door assembly, while improving window regulator efficiency.

An advantage of an embodiment is that the latch/window regulator module with integrated channel/regulators may decrease assembly time and labor.

An advantage of an embodiment is that the integrated channel/regulators eliminate some of the components from the center of the lower portion of the door, which may allow door trim to extend farther outboard, thus increasing interior room/storage pockets on the door.

An advantage of an embodiment is that the latch/window regulator module and integrated channel/regulators can be employed without requiring complete redesign of conventional vehicle door structure. And, this is accomplished while maintaining door structural capability.

### BRIEF DESCRIPTION OF THE DRAWINGS

FIG. 1 is a side elevation view of a portion of a vehicle door.

FIG. 2 is a perspective view of a portion of a latch/window regulator module mounted to a door inner panel.

FIG. 3 is a perspective view of a portion of the latch/window regulator assembly, viewed from an outboard direction.

FIG. 4 is a view similar to FIG. 3, but viewed from an inboard direction.

FIG. 5 is a view similar to FIG. 3, but viewed from a rearward direction.

FIG. 6 is a perspective view of a forward portion of the latch/window regulator assembly.

FIG. 7 is a schematic illustration of a window glass engaging an integral channel/regulator.

### DETAILED DESCRIPTION

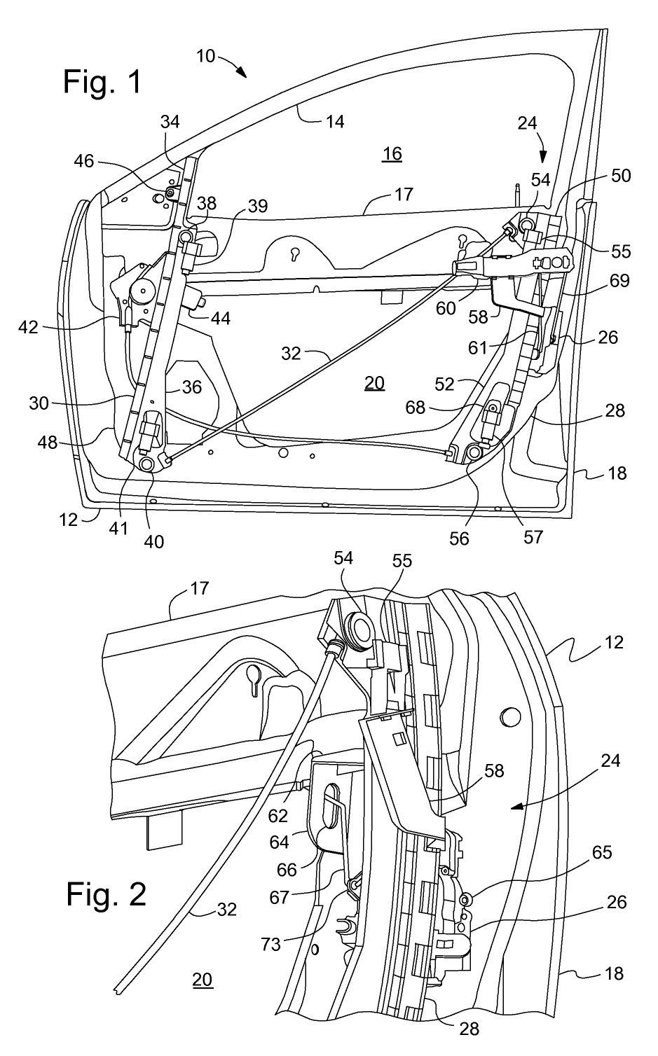

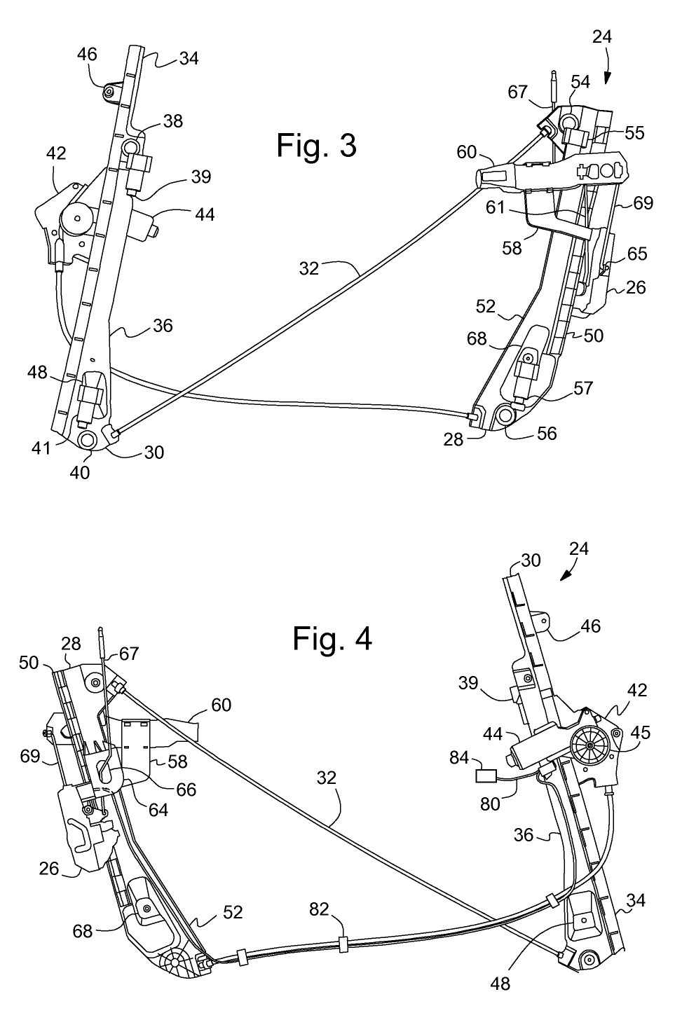

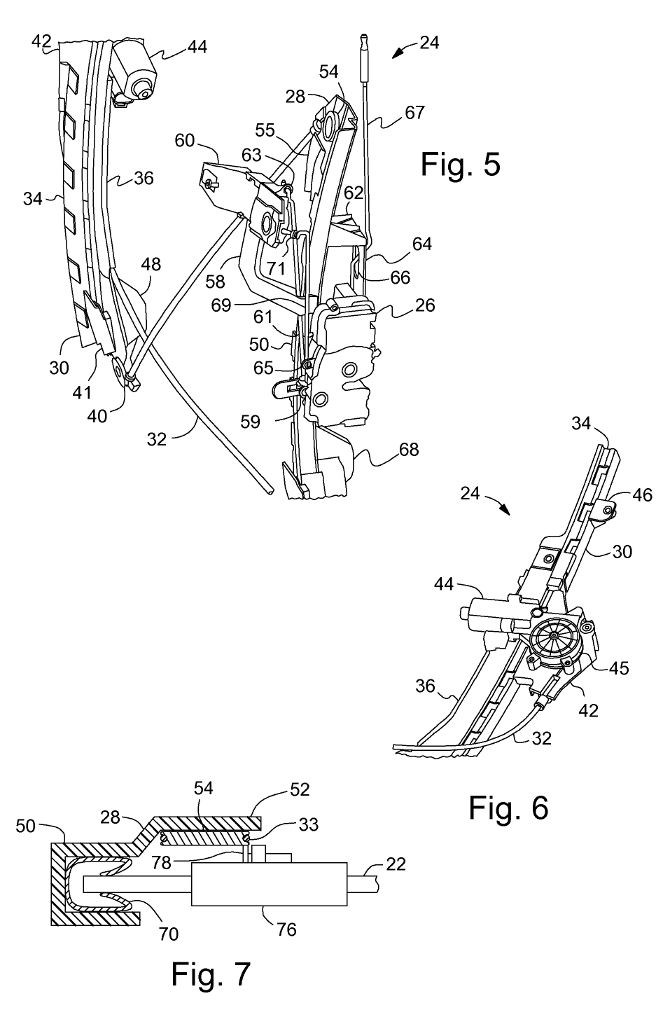

FIGS. 1-7 illustrate various portions of a vehicle door 10, having a door inner panel 12. The door inner panel 12 includes structure forming a window frame 14 that defines a window opening 16, the bottom edge 17 of which is generally referred to as a beltline, and other structure forming a lower door portion 18 that defines an access hole 20. The access hole 20 allows various components and sub-assemblies, such as a latch/window regulator module 24, to be assembled into the door 10.

The latch/window regulator module 24 is mounted to the door inner panel 12. The latch/window regulator module 24 includes a door latch assembly 26 mounted to a rear integrated channel/regulator 28, a forward integrated channel/regulator 30, and a window regulator cable assembly 32 (cable 33 only shown in FIG. 7). The window regulator cable assembly 32 is mounted to and extends between the rear and forward integrated channel/regulators 28, 30.

The forward integrated channel/regulator 30 may include a forward glass run channel 34 that is integral with and extends from a forward window regulator guide rail 36. The forward glass run channel 34 may extend somewhat above the beltline 17. A top front pulley 38, a top front cable guide 39, a bottom front pulley 40 and a bottom front cable guide 41 may mount to the forward guide rail 36 and guide the cable 33—part of the window regulator cable assembly 32 that controls the vertical movement of a window glass 22 (shown only in FIG. 7). An integral motor flange 42 may extend from the forward integrated channel/regulator 30 and provide support for a motor 44 and cable drum 45. Integral upper and lower mounting flanges 46, 48, respectively, may provide locations for securing the forward integrated channel/regulator 30 to the door inner panel 12. In addition, an integral speaker box (not shown) may extend from the forward integrated channel/regulator 30—this would allow a speaker to be mounted prior to assembly into the door. As one will note, several different functions are performed within the door by the various features integrated into the forward integrated channel/regulator 30. Preferably, the forward integrated channel/regulator 30 is a molded plastic part, allowing these various portions to be formed integrally. The forward integrated channel/regulator 30 also may be made of magnesium instead, if so desired. Alternatively, the forward integrated channel/regulator 30 may be a roll formed metallic piece, with the glass run channel 34 formed integral with the window regulator guide rail 36. However, with a roll formed metallic piece, some of the other features may need to be formed separately and then attached to the integrated channel/regulator 30.

The term integral, as used herein, means that the particular elements are formed as a single monolithic piece rather than being formed separately and later assembled and secured together.

The rear integrated channel/regulator 28 also has various portions that, while being mostly formed from an integral piece, perform different functions within the door 1 0. The rear integrated channel/regulator 28 may include a rear below belt glass run channel 50 that is integral with and extends from a rear window regulator guide rail 52. A top rear pulley 54, a top rear cable guide 55, a bottom rear pulley 56 and a bottom rear cable guide 57 may mount to the guide rail 52 and guide the cable 33—part of the window regulator cable assembly 32 that controls the vertical movement of the window glass 22. The rear integrated channel/regulator 28 may be made from plastic or magnesium. Alternatively, the rear integrated channel/regulator 28 may be a roll formed metallic piece, with the glass run channel 50 formed integral with the window regulator guide rail 52. However, with a roll formed metallic piece, some of the other features may need to be formed separately and then attached to the integrated channel/regulator 28.

An integral outside door handle support flange 58 may extend from the rear integrated channel/regulator 28 and support an outside handle chassis 60. The door latch assembly 26 includes a latch lever 59 to which an outside handle lever rod 61 is connected, which, in turn, connects to a handle lever 63 on the outside handle chassis 60. The door latch assembly 26 may also include a lock lever 65 to which a lock rod 69 is attached, which, in turn, attaches to a key cylinder lever 71 on the chassis 60. A locking rod flange 62 may be integral with and extend from the rear integrated channel/regulator 28 and include a portion that forms a locking rod carrier 64. The locking rod carrier 64 may include a rod pass through hole 66 through which a vertical locking rod 67 passes and connects to a locking rod latch lever 73 on the door latch assembly 26. Also, an integral rear/lower door mounting flange 68 may extend from the rear integrated channel/regulator 28 and provide a location for securing the channel/regulator 28 to the door inner panel 12. A glass guide insert 70 (shown in FIG. 7) mounts in the below belt glass run channel 50 and guides a rear edge of the window glass 22 therein. The glass guide insert 70 may be made of rubber or more preferably EPDM (ethylene propylene diene monomer).

Glass clips 76 (only one shown in FIG. 7) mount to the underside of the window glass 22 and include fittings 78 that are secured to and actuated by the cable 33. The cable 33 extends around and is guided by the pulleys 40, 42, 54, 56 and cable guides 39, 41, 55, 56, thus defining the motion of the window glass 22 as the cable 33 is wound and unwound from the cable drum 45 by the motor 44.

A wiring harness 80 (only shown in FIG. 4) providing power to the motor 44 and the door latch assembly 26 may extend along a portion of the window regulator cable assembly 32, and be secure thereto by clips 82. A wiring harness connector 84 may be located adjacent to the motor 44 near the front of the door, for ease of connection to a wiring harness (not shown) extending from the car body (not shown) through the door hinge area (not shown). While the wiring harness 80 is shown extending along one portion of the window regulator cable assembly 32, of course it may be secured to the other portion instead, if so desired. The ability to allow the wiring harness 80 to be clipped to and carried by the window regulator cable assembly 32 is provided by the fact that the door latch assembly 26 is mounted to and carried by the rear integrated channel/regulator 28 and the motor 44 is mounted to and carried by the forward integrated channel/regulator 30. Such an arrangement allows for pre-assembly of many components before installation into the door 10.

Pre-assembled components of the latch/window regulator module 24, then, may be inserted through the access hole 30 and secured to the door inner panel 22, rather than assembling the components after insertion into the door 10. The rear integrated channel/regulator 28 allows for pre-assembly of some components before assembly into the door 10. The door latch assembly 26 and the outside door handle chassis 60 may be mounted to the rear integrated channel/regulator 28, as well as the glass guide insert 70. The outside handle lever rod 61, vertical locking rod 67, and lock rod 69 may also be pre-assembled. The forward integrated channel/regulator 30 also allows for pre-assembly of some components before assembly into the door 10. The motor 44 and cable drum 45 may be mounted to the forward integrated channel/regulator 30. Also, the window regulator cable assembly 32 and wiring harness 80 may be pre-assembled to the latch/window regulator module 24. All of these pre-assembled components of the latch/window regulator module 24, then, may be inserted through the access hole 20 and secured to the door inner panel 12. Consequently, far less of the assembly work for a vehicle assembler needs to be accomplished within the door itself.

Once installed, the latch/window regulator module 24, employing the rear and forward integrated channel regulators 28, 30, both guides the window glass 22 and controls its up and down motion. The rear and forward integrated channel/regulators 28, 30 guide the window glass 22 both inboard/outboard as well as fore/aft. The pulleys 38, 40, 54, 56 mount to the integrated channel/regulators 28, 30 and cooperate with the cable guides 39, 41, 55, 57, window regulator cable assembly 32, and cable drum 45 to guide the cable 33. The motor 44, mounted to the forward integrated channel/regulator 30, can then drive the cable 33, which, in turn, controls the movement of the window glass support clips 76 to raise and lower the window glass 22.

While certain embodiments of the present invention have been described in detail, those familiar with the art to which this invention relates will recognize various alternative designs and embodiments for practicing the invention as defined by the following claims.

What is claimed is:

1. A rear integrated channel/regulator mountable to a door inner panel of a vehicle door for guiding a window glass, the rear integrated channel/regulator comprising:
a rear glass run channel shaped to slidably receive the window glass;
a rear window regulator guide rail, extending from and integral with the rear glass run channel, including a top rear pulley and a bottom rear pulley rotatably mounted to the rear window regulator guide rail and adapted to guide a cable therearound; and
a door handle support flange extending from the rear glass run channel.

2. The rear integrated channel/regulator of claim 1 including a door latch assembly mounted to the rear glass run channel.

3. The rear integrated channel/regulator of claim 1 wherein the door handle support flange is integral with the rear glass run channel.

4. The rear integrated channel/regulator of claim 1 including an outside handle chassis mounted on the door handle support flange.

5. The rear integrated channel/regulator of claim 1 including a locking rod carrier extending from the rear window regulator guide rail that includes a rod pass through hole for receiving a vertical locking rod therethrough.

6. The rear integrated channel/regulator of claim 1 including a door mounting boss extending from the rear window regulator guide rail and securable to the door inner panel.

7. The rear integrated channel/regulator of claim 1 wherein the rear glass run channel, the rear window regulator guide rail, and the door handle support flange are all integral and made of a plastic material.

8. A latch/window regulator module mountable in a vehicle door for guiding and moving a window glass, the latch/window regulator module comprising:
a rear integrated channel/regulator including a rear glass run channel shaped to slidably receive the window glass, and a rear window regulator guide rail, extending from the rear glass run channel, including a top rear pulley and a bottom rear pulley rotatably mounted to the rear window regulator guide rail;
a forward integrated channel/regulator including a forward glass run channel shaped to slidably receive the window glass, and a forward window regulator guide rail, extending from the forward glass run channel, including a top front pulley and a bottom front pulley rotatably mounted to the forward window regulator guide rail;
a door latch assembly mounted to the rear integrated channel/regulator; and
a window regulator cable assembly operatively engaging the top rear pulley, the bottom rear pulley, the top front pulley and the bottom front pulley.

9. The latch/window regulator module of claim 8 including a wiring harness operatively engaging the door latch assembly and a plurality of clips, the plurality of clips securing the wiring harness to the window regulator cable assembly.

10. The latch/window regulator module of claim 8 wherein the forward integrated channel/regulator includes a motor flange extending therefrom, and a motor and a cable drum mounted on the motor flange.

11. The latch/window regulator module of claim 8 wherein the rear integrated channel/regulator includes a door handle support flange extending from the rear glass run channel.

12. The latch/window regulator module of claim 8 wherein the rear glass run channel and the rear window regulator guide rail are integral.

13. The latch/window regulator module of claim 12 wherein the forward glass run channel and the forward window regulator guide rail are integral.

14. The latch/window regulator module of claim 8 wherein the forward glass run channel and the forward window regulator guide rail are integral.

15. The latch/window regulator module of claim 8 wherein the rear window regulator guide rail includes a locking rod carrier extending therefrom and including a rod pass through hole, and the latch/window regulator module includes a vertical locking rod operatively engaging the door latch assembly and extending through the rod pass through hole.

16. The latch/window regulator module of claim 8 wherein the rear integrated channel/regulator includes a door handle support flange extending from the rear glass run channel, the door handle support flange being integral with the rear glass run channel.

17. A forward integrated channel/regulator mountable to a door inner panel of a vehicle door for guiding a window glass, the forward integrated channel/regulator comprising:
a forward glass run channel shaped to slidably receive the window glass;
a forward window regulator guide rail, extending from and integral with the forward glass run channel, including a top front pulley and a bottom front pulley rotatably mounted to the forward window regulator guide rail and adapted to guide a cable therearound;
a motor flange, extending from and integral with the forward glass run channel and forward window regulator guide rail; and
a cable drum mounted to the motor flange and adapted to operatively engage the cable.

18. The forward integrated channel/regulator of claim 17 including a motor mounted to the motor flange and operatively engaging the cable drum.

19. The forward integrated channel/regulator of claim 17 wherein the forward glass run channel, the forward window regulator guide rail, and the motor flange are all made of a plastic material.

20. The forward integrated channel/regulator of claim 17 including an upper mounting flange extending from and integral with the forward glass run channel, and a lower mounting flange extending from and integral with the forward window regulator guide rail.
